(19) United States
(12) Patent Application Publication
(10) Pub. No.: US 2007/0186159 A1
(43) Pub. Date: Aug. 9, 2007

(54) Universal text input method for different languages

(75) Inventor: Wan-ping Yang, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 11/350,378

(22) Filed: Feb. 8, 2006

(51) Int. Cl. G06F 17/00

(52) U.S. Cl. 715/535

(57) ABSTRACT

An electronic device such as a navigation system includes an input device for inputting information into the electronic device. The input device includes a selection device for selecting one of a plurality of characters from one of a plurality of languages. An election device inputs the selected character into the electronic device.

### FIELD

The present disclosure relates to an input device for an electronic system. More particularly, the present invention relates to an input device for an electronic system which is capable of inputting characters in a plurality of languages.

### BACKGROUND

The statements in this section merely provide background information related to the present disclosure and may not constitute prior art.

Many electronic systems require input from a user. In some instances, such input is in the form of a simple yes/no or an on/off function. These simple inputs can be accomplished using switches and/or buttons. In other instances, such input may be more complex requiring the use of an input device having various characters which can be alpha-numeric characters and/or other symbols.

With the more complex inputs, a physical keyboard or other type of character input device is typically utilized as the input device to allow the user the ability to input information in various forms. Keyboards or a form thereof, are used for data entry in a myriad of devices including computers, ATMs, kiosks, navigation systems, toys and the like. The term keyboard or character entry device as used herein is meant to mean any type of character entry device which allows character by character input of data and not just a computer or typewriter keyboard.

One electronic system which can require user input is a navigation system. A navigation system for automotive vehicles is designed to provide course guidance for travel to a desired destination to a driver who is unfamiliar with the local geography or who is unfamiliar with the location of a specific place. Navigation systems are becoming more and more popular as an option for an automotive vehicle.

In navigation devices, a navigation destination may be entered by a user by inputting a town name, a city name, a street name and/or a street address. The inputting of the information to the navigation system requires the use of a character entry device. With the globalization of the automotive industry, separate character entry devices are required for the language of each country within which the navigation system is marketed. This increases the complexity of the navigation system when it is going to be marketed in a plurality of countries.

For example, the English language is generally written using an alphabet of twenty-six letters where the letters were derived from the Romans. Other languages, however, employ significantly greater number of written characters. One example of a written language that requires a relative large number of written characters is the Japanese language.

Japanese typically utilizes several different writing systems in conjunction with each other to form a single unified written language system. For example, Hiragana and Katakana are parallel phonetic systems that each use over forty characters. Hiragana is used primarily to write words of Japanese origin, while Katakana is used primarily to write words of non-Japanese origin. Furthermore, modern written Japanese occasionally incorporates foreign words written in the previously mentioned Roman alphabet. Thus, implementing a Japanese character input device to support the extended number of written characters using the Hiragana and Katakana systems will require a different character input device than the one for the Roman alphabet and it will typically not include the Roman alphabet. In addition, Kanji is an ideographic system of writing which utilizes thousands of different characters which each typically correspond to specific Japanese words. Thus the Kanji system cannot be utilized in a typical character input device.

Chinese, like the Japanese Kanji, does not have a manageable number of alphabet letters that can be accessed using a typical character input device. Chinese does not use an alphabet but instead it has about five thousand to seven thousand commonly used characters. Thus, Chinese, like Kanji, cannot be utilized in a typical character input device. Advantageously, many phonetic systems have been developed to standardize the pronunciation of, for example, Mandarin Chinese. One such system is the Zhuyin system for Mandarin Chinese which has a thirty-seven symbol phonetic alphabet. Implementation of a Chinese character input device to support the Zhuyin system or other Chinese systems will require yet a different character input device that is different from the one for the Japanese language and is different from the one for the Roman alphabet.

While providing language specific character input devices has been effective, the coordination of the specific character input device and the country of its destination creates complexities that add to the costs of the navigation system. In addition, when an individual travels from his home country to a foreign country and rents or buys a vehicle, he may prefer to input information in his native language and not the language of the country he is visiting.

### SUMMARY

A navigation system includes a character input device where a plurality of languages are available for the inputting of characters. Using a single character input device having multiple language capabilities significantly reduces the proliferation of different models of character input devices and provides a single character input device that can be utilized in a plurality of markets.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a vehicle equipped with a navigation system utilizing the character input device in accordance with the present invention;

FIG. 2 is a block diagram illustrating an electronic structure of a navigation system utilizing the character input device in allowance with the present invention;

FIG. 3 is an enlarged view of the navigation system illustrated in FIG. 1;

FIG. 4 is an enlarged view of the character input device illustrated in FIGS. 1 and 3; and

FIG. 5 is an enlarged view similar to FIG. 4 but illustrating a character input device in accordance with another embodiment of the present invention.

### DETAILED DESCRIPTION

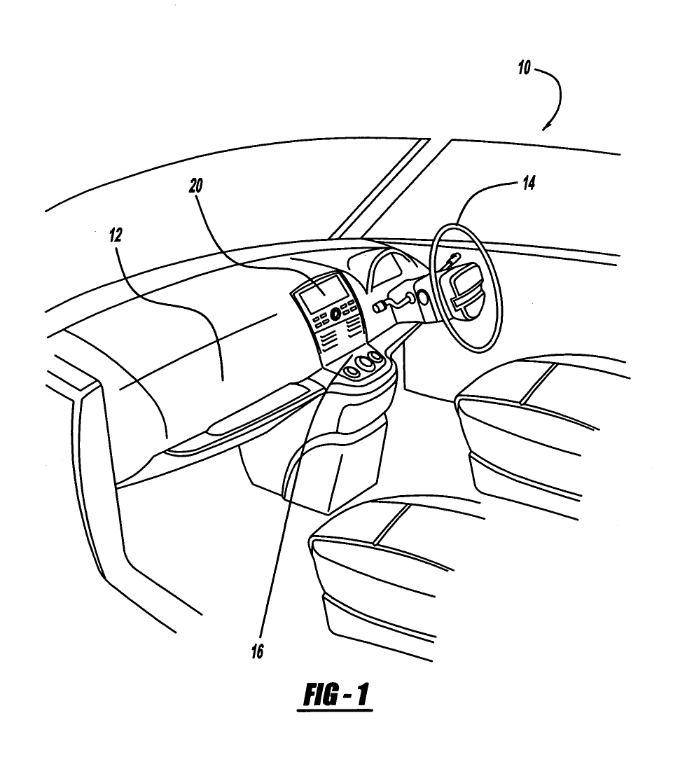

The following description is merely exemplary in nature and is not intended to limit the present disclosure, application, or uses. There is illustrated in FIG. 1, a vehicle which incorporates a navigation system having a character input device in accordance with the present invention and which is designated generally by the reference numeral 10. While the character input device according to the present invention is being illustrated in conjunction with a vehicle navigation system, the character input device of the present invention can be utilized with other electronic systems or devices.

Vehicle 10 comprises a dashboard 12, a steering wheel 14 and a center console 16. Center console 16 includes controls for various features of vehicle 10 such as air conditioning, radio/CD player as well as other controls for features of vehicle 10 known well in the art. A navigation system 20 is also disposed within center console 16. While navigation system 20 is disposed as being within center console 16, navigation system 20 can be located in other positions within vehicle 10 if desired.

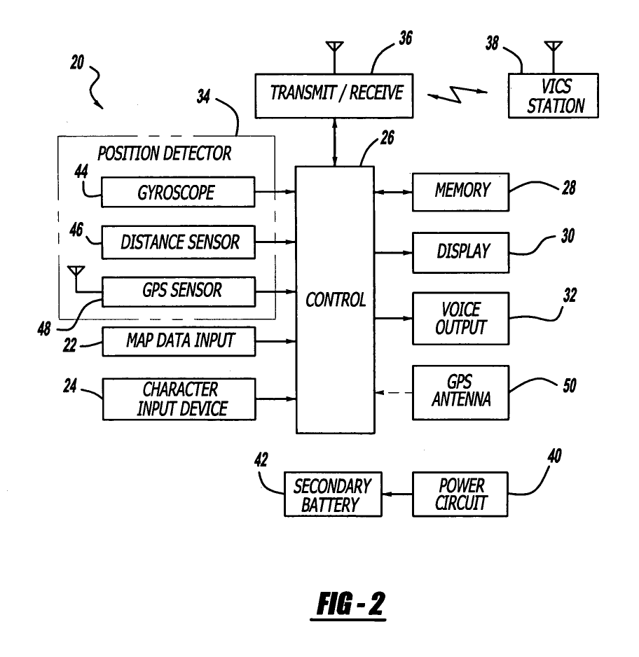

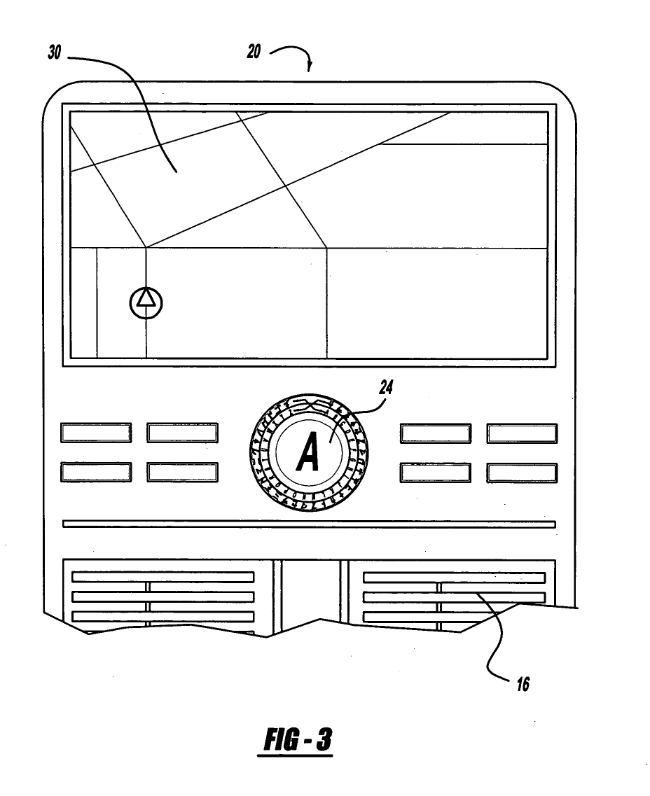

Referring to FIGS. 2 and 3, an electronic circuit of navigation system 20 comprises a map data input unit 22, a character input device 24, a controller 26, an external memory 28, a liquid crystal display (LCD) 30, and a voice output unit 32. In addition a position detector 34 and a transmitter/receiver 36 which are part of a vehicle information and communication system 38 are connected to navigation system 20.

A power circuit 40 powers the above electronic circuits while it stabilizes a voltage of a car battery (not shown). Power circuit 40 charges a secondary battery 42 while navigation system 20 is turned off. Secondary battery 42 provides a power backup for the car battery. Controller 26, formed as a computer, is provided with well known devices such as a CPU, ROM, RAM, I/O and bus line connected with the above discussed devices.

Position detector 34 is provided with also well known devices. These devices includes a gyroscope 44, a distance sensor 46 and a global positioning system (GPS) receiver 48 for positioning vehicle 10 using radio waves from GPS satellites received by a GPS antenna 50. Inherent tolerances of the devices require interpolation using a plurality of sensors. High positioning accuracy may require adding sensors such as a geomagnetic sensor, a steering rotation sensor and wheel sensors. The speed of vehicle 10 may be directly inputted to controller 26 or it can be determined using distance sensor 46.

Map data input 22 is for putting various data such as map-matching data for improving the position accuracy, map data and landmark data. The memory size of the data often needs to utilize a compact disc (CD), a digital versatile disc (DVD), a memory card or an undetachable hard disc drive (HDD).

LCD 30 is capable of superimposition. A vehicle position mark from position detector 34, map data from map data input 22, input from character input device 24 and additional data such as a guiding route are superimposed according to instructions from controller 26.

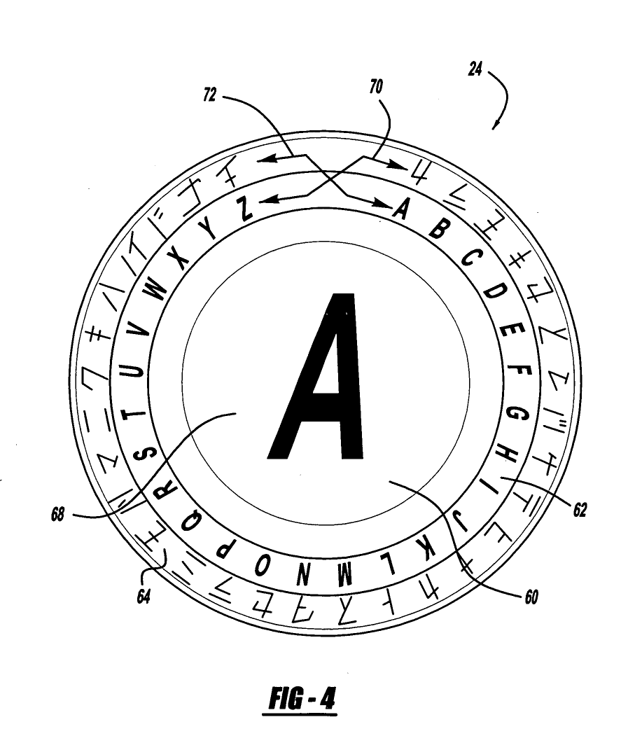

Navigation system 20 is capable of receiving user input through character input device 24. Referring to FIG. 4, character input device 24 comprises a section device or control knob 60, a first set of characters 62 and a second set of characters 64. The first set of characters 62 is a set of characters in a first language such as the Roman alphabet. The second set of characters 64 is a set of characters in a second language such as Japanese. While the first and second set of characters 62 and 64 are illustrated as being positioned around control knob 60, it is within the scope of the present invention to have the first and second set of characters display in other places such as LCD 30 or other display screens known in the art. Control knob 60 rotates in both a clockwise direction and a counter-clockwise direction in order to select a specific character from one of the two languages such as the character “A” illustrated in FIG. 4. Control knob 60 includes a lighted display 68 within which the selected character is displayed. While FIG. 4 illustrates control knob 60 as having lighted display 68, it is within the scope of the present invention to have the selected character displayed in other ways including but not limited to a display on LCD 30 or on a separate display screen. Once the user has selected a desired character, control knob 60 acts as an election device or push button and can be pushed to input the selected character into controller 26 which will then display the selected character on LCD 30. While control knob 60 is being described as being able to be pushed to input the selected character, a separate push button or other input device can act as the election device. The user continues to input characters through the manipulation of control knob 60 until the desired information has been input to controller 26.

Arrows 70 and 72 illustrate the sequence of movement between the first set of characters 62 and the second set of characters 64. During clockwise rotation of control knob 60, when the last character of the first set of characters 62 is reached, continued clockwise rotation of control knob 60 will move to the first character of the second set of characters 64. During counter-clockwise rotation of knob 60, when the first character of the second set of characters 64 is reached, continued counter-clockwise rotation of control knob 60 will move to the last character of the first set of characters 62. This is illustrated by arrow 70. In a similar manner, movement between the last character of the second set of characters 64 and the first character of the first set of characters 62 occurs as illustrated by arrow 72.

The incorporation of character input device 24 and the plurality of character sets 62 and 64 provides a more universal character input device which can now be used in countries which utilize either the first language or the second language.

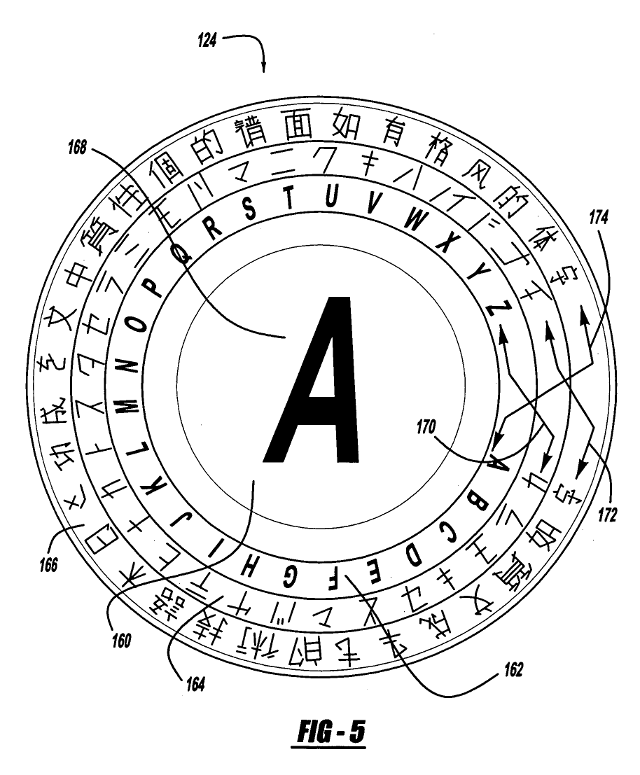

Referring now to FIG. 5, a character input device 124 in accordance with another embodiment of the present invention is illustrated. Character input device 124 is the same as character input device 24 except that character input device 124 allows for three different languages rather than two. While character input device 24 allows two languages and character input device 124 allows three languages, the present invention is not limited to two or three languages as additional languages can be added by adding additional rings having additional languages.

Character input device 124 comprises a control knob 160, a first set of characters 162, a second set of characters 164 and a third set of characters 166. The first set of characters 162 is a set of characters in a first language such as the Roman alphabet. The second set of characters 164 is a set of characters in a second language such as Japanese. The third set of characters 166 is a set of characters in a third language such as Chinese. Control knob 160 rotates in both a clockwise direction and a counter-clockwise direction in order to select a specific character of one of the three languages such as the character “A” illustrated in FIG. 5. Control knob 160 includes a lighted display 168 within which the selected character is displayed. Once the user has selected a desired character, control knob 160 acts as an election device and can be pushed to input the selected character into controller 26 which will then display the selected character on LCD 30. The user continues to input characters through the manipulation of control knob 160 until the desired information has been input to controller 26.

Arrows 170, 172 and 174 illustrate the sequence of movement between the first set of characters 162, the second set of characters 164 and the third set of characters 166. During clockwise rotation of control knob 160, when the last character of the first set of characters 162 is reached, continued clockwise rotation of control knob 160 will move to the first character of the second set of characters 164. During counter-clockwise rotation of control knob 160, when the first character of the second set of characters 164 is reached, continued counter-clockwise rotation of control knob 160 will move to the last character of the first set of characters 162. This is illustrated by arrow 170. In a similar manner, movement between the last character of the second set of characters 164 and the first character of the third set of characters 166 occurs as illustrated by arrow 172. Finally, in a similar manner, movement between the last character of the third set of characters 166 and the first character of the first set of characters 162 occurs as illustrated by arrow 174.

The incorporation of character input device 124 and the plurality of character sets 162, 164 and 166 provide a more universal character input device which can now be used in countries which utilize either the first language, the second language or the third language.

What is claimed is:

1. An electronic system comprising:
an electronic device;
an input device for inputting data into the electronic device, the input device comprising:
a first set of selectable characters in a first language;
a second set of selectable characters in a second language, the second language being different than the first language;
a selection device for selecting one character from the first and second sets of selectable characters; and
an election device for inputting the one character into the electronic device.

2. The electronic system according to claim 1, wherein the electronic device is a navigation system.

3. The electronic system according to claim 1, wherein the selection device is a rotatable knob.

4. The electronic system according to claim 3, wherein the election device is a push button.

5. The electronic system according to claim 4, wherein the push button is the rotatable knob.

6. The electronic system according to claim 1, wherein the election device is a push button.

7. The electronic system according to claim 1, wherein the input device further comprises a display for displaying the selected character.

8. The electronic system according to claim 1, wherein the input device further comprises a third set of selectable characters in a third language, the third language being different from the first and second languages, the selection device being adapted to select the one character from the first, second and third sets of selectable characters.

9. The electronic system according to claim 8, wherein the electronic device is a navigation system.

10. The electronic system according to claim 8, wherein the selection device is a rotatable knob.

11. The electronic system according to claim 10, wherein the election device is a push button.

12. The electronic system according to claim 11, wherein the push button is the rotatable knob.

13. The electronic system according to claim 8, wherein the election device is a push button.

14. The electronic system according to claim 8, wherein the input device further comprises a display for displaying the selected character.
